(19) United States
(12) Patent Application Publication
(10) Pub. No.: US 2005/0181945 A1
(43) Pub. Date: Aug. 18, 2005

(54) Thermal recording material for offset printing

(76) Inventors: Katsuyoshi Takagi, Tokyo (JP); Akira Nakayama, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/509,241

(22) PCT Filed: Mar. 27, 2003
(86) PCT No.: PCT/JP03/03873

(30) Foreign Application Priority Data
Mar. 28, 2002 (JP) 2002-90614

(51) Int. Cl. B41M 5/20

(52) U.S. Cl. 503/226

(57) ABSTRACT

Provided is a thermal recording material having excellent offset printability, having a support, a thermal recording layer and a protective layer containing a pigment and a resin, the thermal recording layer being formed on the support, the protective layer being formed on the thermal recording layer, wherein the transfer amount of water on the surface of said protective layer for a contact time period of 150 ms, measured by a Bristow method, is 3 ml/m² to 15 ml/m² and the contact angle between the surface of said protective layer and water is 60° to 100°.

### TECHNICAL FIELD

The present invention relates to a thermal recording material, more specifically to a thermal recording material having a protective layer that is excellent in offset printability and at the same time exhibits suitable surface strength and color developability in thermal printing.

### TECHNICAL BACKGROUND

Generally, a thermal recording material has a substrate and a heat-sensitive recording layer formed thereon, the heat-sensitive recording layer containing, as main components, a colorless or light-colored electron-donating dye precursor and an electron-accepting compound (developer). When the thermal recording material is heated with a thermal head, a hot pen or a laser beam, the dye precursor and the developer readily react with each other to give a recorded image. Such thermal recording materials give recordings with a relatively simple apparatus and have advantages that their maintenance is easy and that they make no noise. They are used in broad fields of measuring recorders, facsimile machines, printers, computer terminals, labels, automatic vending machines of railway tickets, and the like.

In recent years, particularly, thermal recording materials have come to be used as accounting-related recording sheets such as various receipts, CD/ATM slips of banking facilities, receipts of gas, water and electricity issued with a handy terminal, and the like. Thermal recording materials for use therefor are required to satisfy the following; the amount of residues adhering to the thermal head of a thermal printer should be small, so that no printing failure is to take place in long-distance printing even without carrying out any maintenance/checkout such as the cleaning of the thermal head. The soiling of a developed color due to an external pressure, scratching, etc., should not take place (resistance to rubbing-induced fogging), and a recorded surface should not be peeled off even if it is wetted with rainwater (water resistance) (for example, see JP-A-2-169291). For the purpose of decreasing the deposit of residues on a thermal head and improving a thermal recording material in resistance to rubbing-induced fogging and water resistance, generally, there is well known a method in which a protective layer is formed on a thermal recording layer (for example, see JP-A-9-263049, JP-A-10-147059 and JP-A-5-294067).

In the above thermal recording materials for use as accounting-related recording sheets, it is mostly required to apply offset printing, and there are increasingly demanded thermal recording materials excellent in the lithographic offset printability using a dampening solution. When the above protective layer is formed, however, the protective layer is mostly formed from a resin, so that it has picking resistance, while it is said that the protective layer is unsuitable for offset printing since the protective layer is poor in the property of taking ink and the property of properly absorbing water. As a method of improving the offset printability of a thermal recording material having a protective layer, there is known a method in which binders for an undercoat layer and a protective layer are specified, and there is known a recording material having a specific relationship between a contact angle to water and a contact angle to linseed oil, while they are not sufficient (for example, see JP-A-7-149048 and JP-A-4-82777).

### DISCLOSURE OF THE INVENTION

It is an object of the present invention to provide a thermal recording material comprising a support, a thermal recording layer formed thereon and a protective layer formed on the thermal recording layer, which thermal recording material is excellent in offset printability and at the same is excellent in surface strength and thermal printability. For achieving the above object, the present inventors have made diligent studies and as a result have found that the above object can be achieved when the transfer amount of water on the protective layer surface and the contact angle between the surface of the protective layer and water are in predetermined ranges. The present invention has been accordingly completed.

That is, the present invention is directed to;
(1) a thermal recording material for offset printing, comprising a support, a thermal recording layer for thermally developing a color and a protective layer containing a pigment and a resin, the thermal recording layer being formed on the support, the protective layer being formed on the thermal recording layer, wherein the transfer amount of water on the surface of said protective layer for a contact time period of 150 ms, measured by a Bristow method, is 3 ml/m² to 15 ml/m² and the contact angle between the surface of said protective layer and water is 60° to 100°,
(2) the thermal recording material for offset printing as recited in the above (1), wherein the transfer amount of water on the surface of said protective layer for a contact time period of 150 ms, measured by a Bristow method, is 7 ml/m² to 10 ml/m²,
(3) the thermal recording material for offset printing as recited in the above (1), wherein the contact angle between the surface of said protective layer and water is 70° to 90°,
(4) the thermal recording material for offset printing as recited in the above (1), wherein the surface of said protective layer has a center plane average roughness (SRa), measured with a stylus type three-dimensional surface roughness tester, of 0.6 μm to 2 μm in a coating direction at a cutoff value of 0.8 mm,
(5) the thermal recording material for offset printing as recited in the above (1), wherein the surface of said protective layer has a center plane average roughness (SRa), measured with a stylus type three-dimensional surface roughness tester, of 0.6 μm to 1 μm in a coating direction at a cutoff value of 0.8 mm,
(6) the thermal recording material for offset printing as recited in the above (1), wherein the pigment contained in the said protective layer has an oil absorption, measured according to JIS-K-5101, of 200 ml/100 g to 350 ml/100 g,
(7) the thermal recording material for offset printing as recited in the above (1), wherein the pigment contained in the said protective layer has an oil absorption, measured according to JIS-K-5101, of 250 ml/100 g to 300 ml/100 g,
(8) the thermal recording material for offset printing as recited in any one of the above (1), (2), (4) and (6), wherein the resin in said protective layer is at least one member of a water-dispersible resin and a non-modified polyvinyl alcohol and said protective layer has a pigment content of 40 mass % to 70 mass % based on the total solid content of said protective layer,
(9) the thermal recording material for offset printing as recited in the above (1), wherein the transfer amount of water on the surface of said protective layer for a contact time period of 150 ms, measured by a Bristow method, is 7 ml/m² to 10 ml/m², the contact angle between the surface of said protective layer and water is 70° to 90°, the surface of said protective layer has a center plane average roughness (SRa), measured with a stylus type three-dimensional surface roughness tester, of 0.7 μm to 2.0 μm in a coating direction at a cutoff value of 0.8 mm, the resin in said protective layer is at least one member of a water-dispersible resin and a non-modified polyvinyl alcohol, the pigment has an oil absorption, measured according to JIS-K-5101, of 250 ml/100 g to 300 ml/100 g and said protective layer has a pigment content of 40 mass % to 70 mass % based on the total solid content of said protective layer,
(10) the thermal recording material for offset printing as recited in the above (1), wherein the resin in said protective layer is a silicon-modified polyvinyl alcohol and the protective layer contains a high-molecular-weight crosslinking agent and a low-molecular-weight crosslinking agent,
(11) the thermal recording material for offset printing as recited in the above (10), wherein said high-molecular-weight crosslinking agent contains a glycidyl group and contains polyamideamine as a main chain,
(12) the thermal recording material for offset printing as recited in the above (10), wherein said low-molecular-weight crosslinking agent is a compound having an aldehyde group,
(13) the thermal recording material for offset printing as recited in the above (10), wherein said high-molecular-weight crosslinking agent contains a glycidyl group and contains polyamideamine as a main chain, and said low-molecular-weight crosslinking agent is a compound having an aldehyde group,
(14) the thermal recording material for offset printing as recited in the above (13), wherein said high-molecular-weight crosslinking agent is contained in an amount of 2 mass % to 10 mass % based on the solid content of the resin in said protective layer and said low-molecular-weight crosslinking agent is contained in an amount of 2 mass % to 8 mass % based on the solid content of the resin in said protective layer,
(15) the thermal recording material for offset printing as recited in the above (10), wherein the surface of said protective layer has a center plane average roughness (SRa), measured with a stylus type three-dimensional surface roughness tester, of 0.6 μm to 2 μm in a coating direction at a cutoff value of 0.8 mm,
(16) the thermal recording material for offset printing as recited in the above (10), wherein said protective layer has a pigment content of 10 mass % to 50 mass % based on the total solid content of said protective layer, and
(17) the thermal recording material for offset printing as recited in the above (13), wherein the transfer amount of water on the surface of said protective layer for a contact time period of 150 ms, measured by a Bristow method, is 3 ml/m² to 10 ml/m², the contact angle between the surface of said protective layer and water is 70° to 90°, the surface of said protective layer has a center plane average roughness (SRa), measured with a stylus type three-dimensional surface roughness tester, of 0.6 μm to 2 μm in a coating direction at a cutoff value of 0.8 mm, and said protective layer has a pigment content of 10 mass % to 50 mass % based on the total solid content of said protective layer.

### PREFERRED EMBODIMENTS OF THE INVENTION

The thermal recording material of the present invention is a material in which a thermal recording layer for thermally developing a color and a protective layer containing a resin and a pigment are consecutively formed on a support. In the thermal recording material, the transfer amount of water on the surface of the above protective layer for a contact time period of 150 ms, measured by a Bristow method (J. TAPPI paper pulp testing method No. 51-87; to be simply referred to as “Bristow method” hereinafter), is 3 ml/m² to 15 ml/m², and the contact angle between the surface of the above protective layer and water is 60° to 100°.

First, the numerical requirements of the protective layer of the thermal recording material of the present invention will be explained. As a method of evaluating the permeability of water to paper, etc., conventionally, there are used a Stockigt sizing degree test and a Cobb sizing degree test in addition to the Bristow method in the present invention.

The Bristow method is a method in which a liquid is transferred from a head box having a slit in a lower portion to a test piece on a rotating wheel, and it is an evaluation method using a relationship that the transfer amount of a liquid per unit area after the liquid contacts a paper is in proportion to a square root of a time. As compared with the above Stockigt sizing degree test and the above Cobb sizing degree test, the Bristow method is a method in which the momentary water absorption characteristic of a coating layer surface for one second or less can be accurately grasped, and the thus-obtained data can be an effective index for knowing the permeation behavior of a dampening solution in actual offset printing.

In the thermal recording material of the present invention, the transfer amount of water on the surface of the protective layer for a contact time period of 150 ms, measured by the Bristow method, is limited to 3 ml/m² to 15 ml/m². When the transfer amount of water on the protective layer is less than 3 ml/m², a dampening solution remaining on the protective layer surface decreases the property of taking ink in offset printing. When the transfer amount of water on the protective layer surface exceeds 15 ml/m², the permeation of a dampening solution may decrease the coating layer strength. The transfer amount of water is preferably 7 ml/m² to 10 ml/m².

Further, the contact angle in the present invention refers to a contact angle (°) measured 1 second after a distilled water droplet is dropped on the protective layer surface in an atmosphere of 23° C. and 50% RH. In the present invention, it is required to obtain an accurate data of the wettability of the protective layer surface to water, and the measurement of the contact angle can be an effective index for knowing the behavior of a dampening solution transferred to the protective layer surface in actual offset printing, in addition to the momentary water absorption characteristic of the protective layer surface for 1 second or less, obtained by the above Bristow method. For the measurement of a contact angle in the present invention, there can be used, for example, a FACE automatic contact angle meter supplied by KYOWA INTERFACE SCIENCE CO., LTD.

In the present invention, the contact angle of water on the protective layer surface is limited to 60° to 100°. When the contact angle of water is less than 60°, the replacement of water with ink is impeded, and the adherence of ink is degraded, so that a density non-uniformity or a density decrease in an image portion are liable to take place. Further, when it exceeds 100°, a non-image portion is liable to be soiled. The contact angle of water is preferably 70° to 90°.

Further, the center plane average roughness (SRa) of the above protective layer surface, measured with a stylus type three-dimensional surface roughness tester in a coating direction at a cutoff value of 0.8 mm, is preferably 0.6 μm to 2 μm, more preferably 0.6 μm to 1 μm. When the above ranges are satisfied, there can be obtained a thermal recording material excellent in ink absorptivity, a printed image quality and thermally printed character quality.

The center plane average roughness (SRa) measured with a stylus type three-dimensional surface roughness tester in a coating direction at a cutoff value of 0.8 mm refers to a roughness defined by the following expression 1.

$$SRa = \frac{1}{Sa} {\int }_{0}^{{W}_{x}} {\int }_{0}^{{W}_{y}} \vert f ( x , y ) \vert ⅆ x ⅆ y \qquad [ Equation 1 ]$$

In the expression 1, Wₓ is a length of a sample surface region in the X-axis direction (coating direction), W_{y} is a length of the sample surface region in the y-axis direction (direction perpendicular to the coating direction), and Sa is an area of the sample surface region. Further, f(x,y) is a function showing a roughness of the sample surface on the xy plane.

Specifically, the center plane average roughness (SRa) can be determined, for example, by using a machine model SE-3AK supplied by Kosaka Laboratory Ltd. as a stylus type three-dimensional surface roughness tester and a machine model SPA-11 supplied by Kosaka Laboratory Ltd. as an analyzer at a cutoff value of 0.8 mm under conditions of Wx=20 mm and Wy=8 mm, that is, under the condition of Sa=160 mm². In this case, 500 points are sampled for data processing in the X-axis direction and scanning of 17 lines or more in the Y-axis direction is carried out.

The water absorption characteristic according to the Bristow method, the contact angle property and the center plane average roughness (SRa) can be adjusted depending upon kinds and amount ratios of materials for constituting the protective layer, coating methods, finish methods, and the like.

The method of improving the water absorption characteristic according to the Bristow method includes, for example, methods of using a hydrophilic resin such as polyvinyl alcohol, using a pigment excellent in moisture absorption property, using a larger amount of a pigment component and adjusting a coating method or a finish method to increase the roughness of a thermal paper and other method. The method of increasing the contact angle includes methods of using a hydrophobic resin, using a pigment of which the surface is treated to be hydrophobic, decreasing the amount of a pigment component, adding a crosslinking agent to improve a resin in film formability, adding a hydrophobic material such as WAX and adjusting a coating method or a finish method to smoothen the surface and other method. Since, however, carrying out these methods decreases the water absorption characteristic, it is important to optimize both the water absorption characteristic and the contact angle property, and in the present invention, the water absorption characteristic and the contact angle property are optimized by adjusting them by combining these methods, so that the thermal recording material is improved in offset printability.

The method of adjusting the center plane average roughness (SRa) includes methods of adding a crosslinking agent or adjusting heating to adjust the film formability of a resin, adjusting the particle diameter, kind and amount of a pigment, adjusting a coating method, adjusting a finish method such as calendering, and other method.

In the thermal recording material of the present invention, the protective layer contains a resin and a pigment. The resin that is contained in the protective layer is not specially limited, and the resin is properly selected as required in a relationship to the pigment to be described later, such that the water absorption characteristic on the protective layer according to the Bristow method, the contact angle to water and the center plane average roughness (SRa) come into the specified ranges, while it is preferred to use a water-soluble resin or a water-dispersible resin. The water-soluble resin or the water-dispersible resin can be selected from known water-soluble resins or water-dispersible resins as required. The water-soluble resin is not specially limited. For example, as a polyvinyl alcohol, modified alcohols such as an acetoacetylated modified polyvinyl alcohol, a silicon-modified polyvinyl alcohol, etc., and a non-modified polyvinyl alcohol can be used. Further, the water-soluble resin can be selected from starch or a derivative thereof, cellulose derivatives such as hydroxyethyl cellulose, methyl cellulose, ethyl cellulose and carboxymethyl cellulose, polyvinyl pyrrolidone, polyacrylamide, an acrylamide/acrylate copolymer, an acrylamide/acrylate/methacrylate terpolymer, an alkali salt of polyacrylic acid, an alkali salt of polymaleic acid, an alkali salt of a styrene/maleic anhydride copolymer, an alkali salt of an ethylene/maleic anhydride copolymer, an alkali salt of an isobutylene/maleic anhydride copolymer, sodium alginate, gelatin, casein, an acid neutralization product of chitosan, or the like. Preferably, non-modified polyvinyl alcohol or silicon-modified polyvinyl alcohol can be used.

The non-modified polyvinyl alcohol in the present invention refers to a product that is obtained by hydrolyzing or saponifying polyvinyl acetate, or the like to a proper degree and that is not subjected to modification treatment such as acetoacetylation modification. The silicon-modified polyvinyl alcohol refers to a polyvinyl alcohol containing silicon in the molecule thereof, and it includes a silylated polyvinyl alcohol and a product obtained by copolymerizing vinyl ester and a silicon-containing olefin monomer and then saponifying the resultant copolymer.

Although not specially limited, examples of the water-dispersible resin include a styrene/butadiene copolymer, an acrylonitrile/butadiene copolymer, a methyl acrylate/butadiene copolymer, an acrylonitrile/butadiene/styrene terpolymer, a polyvinyl acetate, a vinyl acetate/acrylate copolymer, an ethylene/vinyl acetate copolymer, polyacrylic ester, a styrene/acrylate copolymer, polyurethane and a core-shell acrylic emulsion. Preferably, core-shell type acrylic emulsions such as “Barrier Star” supplied by Mitsui Chemicals Inc. are included.

The above water-soluble resins or water-dispersible resins may be used singly or as a mixture containing at least two members of these.

Although not specially limited, examples of the pigment that is contained in the protective layer include inorganic pigments such as diatomite, talc, kaolin, calcined kaolin, calcium carbonates including heavy calcium carbonate and precipitated calcium carbonate, magnesium carbonate, zinc oxide, aluminum oxide, aluminum hydroxide, magnesium hydroxide, titanium dioxide, barium sulfate, zinc sulfate, amorphous silica, amorphous calcium silicate and colloidal silica, and organic pigments such as a melamine resin filler, a urea-formalin resin filler, a polyethylene powder and a nylon powder. Preferably, amorphous silica and calcium carbonate are included. These pigments may be used singly or may be used as a mixture containing at least two members of them as required.

Although not specially limited, the average particle diameter of the pigment for use in the protective layer is preferably 2 μm or less for increasing an image density.

As a pigment, a pigment having an oil absorption amount, measured according to JIS-K-5101, of 200 ml/100 g to 350 ml/100 g is preferred, and a pigment having such an oil absorption amount of 250 ml/100 g to 300 ml/100 g is more preferred. Since a pigment having the above oil absorption is used, there can be obtained a thermal recording material that is well-balanced between the water absorption characteristic of the surface of protective layer and the adherence of ink thereto.

When at least one of the water-dispersible resin and the non-modified polyvinyl alcohol is used as a resin, preferably, the protective layer contains the pigment in an amount of 40 mass % to 70 mass % based on the total solid content of the protective layer. When the silicon-modified polyvinyl alcohol is used as a resin for the above protective layer, it is preferred to use the pigment in an amount of 10 mass % to 50 mass % based on the solid content of the protective layer. Since the above compositions are employed, there can be attained a well balance between the excellent water absorption characteristic and the adherence of ink.

The water absorption characteristic of the protective layer can be adjusted by incorporating a crosslinking agent to the protective layer as required. The crosslinking agent for use in the protective layer includes a low-molecular-weight crosslinking agent and a high-molecular-weight crosslinking agent. The low-molecular-weight crosslinking agent includes low-molecular-weight compounds having a molecular weight of 300 or less, such as compounds having an aldehyde group (formalin, etc.), aziridine, dimethylolurea and guanamine. Compounds having an aldehyde group are preferred.

The high-molecular-weight crosslinking agent includes polymer compounds having a molecular weight of greater than 300, such as dialdehyde starch, epoxy resins, higher carboxylic acids, an N-methylolmelamine resin and a compound containing a glycidyl group and having a main chain formed of a polyamideamine. Preferred is a compound containing a glycidyl group and having a main chain formed of a polyamideamine. When the protective layer contains a high-molecular-weight crosslinking agent, the thermal recording material is improved in layer strength due to a crosslinking effect and is improved in offset printability. When a compound containing a glycidyl group and having a main chain formed of a polyamideamine is used, the thermal recording material can be more improved in offset printability.

The content of the high-molecular-weight crosslinking agent in the protective layer based on the solid content of the resin is 2 mass % to 20 mass %, preferably 2 mass % to 10 mass %, more preferably 2 mass % to 5 mass %. Further, the content of the low-molecular-weight crosslinking agent in the protective layer based on the solid content of the resin is preferably 2 mass % to 8 mass %.

When the low-molecular-weight crosslinking agent is used together with the high-molecular-weight crosslinking agent, the effect of protecting the recording surface can be more improved as is the primary object of the protective layer, the necessary coating amount for the protective layer can be decreased, and there can be obtained thermal recording material having high thermal color developing properties, which are all preferred. In this case, preferably, a compound having a glycidyl group and containing a polyamideamine as a main chain is used as a high-molecular-weight crosslinking agent, and a compound having an aldehyde group is used as a low-molecular-weight crosslinking agent. Concerning the contents of these, preferably, the content of the high-molecular-weight crosslinking agent based on the solid content of the resin in the protective layer is 2 mass % to 10 mass %, and the content of the low-molecular-weight crosslinking agent based on the solid content of the resin in the protective layer is 2 mass % to 8 mass %.

In the thermal recording material having the protective layer using a silicon-modified polyvinyl alcohol as a resin and containing the high-molecular-weight crosslinking agent and the low-molecular-weight crosslinking agent, 10 mass % to 50 mass %, based on the total solid content of the protective layer, of a pigment is incorporated into the protective layer, whereby there can be obtained a thermal recording material that is well-balanced between the water absorption characteristic of the surface thereof and the adherence of ink thereto.

The protective layer may contain other additives for preventing the wearing of a head and the sticking, and such other additives include higher fatty acid metal salts such as zinc stearate and calcium stearate, waxes such as paraffin, paraffin oxide, polyethylene, polyethylene oxide, stearic acid amide and castor wax, dispersing agents such as sodium dioctylsulfosuccinate, a surfactant and a fluorescence dye.

The solid coating amount for the protective layer is 0.2 to 10 g/m², preferably 0.5 to 5 g/m². The protective layer may have a multilayer structure formed of two or more layers as required. When the solid coating amount is within the above range, coloring caused on a ground by a frictional heat from scratching or rubbing, which is called “rubbing-induced fogging”, can be prevented and suitable thermal response can be obtained.

The thermal recording layer constituting the thermal recording material of the present invention will be explained. The thermal recording layer is obtained by dispersing a generally colorless or light-colored electron-donating dye precursor and an electron-accepting developer as main components in a binder and coating the thus-obtained coating liquid on a support. The thermal recording layer is locally heated in use, whereby the precursor and the electron-accepting compound readily react with each other to give a recorded image.

Although not specially limited, the dye precursor for use in the thermal recording layer can be selected from those which are generally used in thermal recording materials or pressure-sensitive recording materials. The dye precursor includes, for example, triarylmethane compounds, diphenylmethane compounds, xanthene compounds, thiazine compound and spiro compounds.

(1) Examples of the triarylmethane compounds include 3,3-bis(p-dimethylaminophenyl)-6-dimethylaminophthalide (Crystal Violet Lactone), 3,3-bis(p-dimethylaminophenyl) phthalide, 3-(p-dimethylaminophenyl)-3-(1,2-dimethylindol-3-yl) phthalide, 3-(p-dimethylaminophenyl)-3-(2-methylindol-3-yl) phthalide, 3-(p-dimethylaminophenyl)-3-(2-phenylindol-3-yl) phthalide, 3,3-bis(1,2-dimethylindol-3-yl)-5-dimethylaminophthalide, 3,3-bis(1,2-dimethylindol-3-yl)-6-dimethylaminophthalide, 3,3-bis(9-ethylcarbazol-3-yl)-5-dimethylaminophthalide, 3,3-bis(2-phenylindol-3-yl)-5-dimethylaminophthalide and 3-p-dimethylaminophenyl-3-(1-methylpyrol-2-yl)-6-dimethylaminophthalide.

(2) Examples of the diphenylmethane compounds include 4,4′-bis(dimethylaminophenyl)benzhydrylbenzyl ether, N-chlorophenylleucoauramine and N-2,4,5-trichlorophenylluecoauramine.

(3) Examples of the xanthene compounds include rhodamine B anilinolactam, rhodamine B-p-chloroanilinolactam, 3-diethylamino-7-benzylamino-fluorane, 3-diethylamino-7-octylaminofluorane, 3-diethylamino-7-phenylfluorane, 3-diethylamino-7-chlorofluorane, 3-diethylamino-6-chloro-7-methylfluorane, 3-diethylamino-7-(3,4-dichloroanilino)fluorane, 3-diethylamino-7-(2-chloroanilino)fluorane, 3-diethylamino-6-methyl-7-anilinofluorane, 3-dibutylamino-6-methyl-7-anilinofluorane, 3-dipentylamino-6-methyl-7-anilinofluorane, 3-(N-ethyl-N-tolyl)amino-6-methyl-7-anilinofluorane, 3-piperidino-6-methyl-7-anilinofluorane, 3-(N-ethyl-N-tolyl)amino-6-methyl-7-phenethylfluorane, 3-diethylamino-7-(4-nitroanilino)fluorane, 3-dibutylamino-6-methyl-7-anilinofluorane, 3-(N-methyl-N-propyl)amino-6-methyl-7-anilinofluorane, 3-(N-ethyl-N-isoamyl)amino-6-methyl-7-anilinofluorane, 3-(N-methyl-N-cyclohexyl)amino-6-methyl-7-anilinofluorane, and 3-(N-ethyl-N-tetrahydrofurfuryl)amino-6-methyl-7-anilinofluorane.

(4) Examples of the thiazine compounds include Benzoylluecomethylene blue and p-nitrobenzoylleucomethylene blue.

(5) Examples of the spiro compounds include 3-methylspironaphthopyran, 3-ethylspirodinaphthopyran, 3,3′-dichlorospirodinaphthopyran, 3-benzylspirodinaphthopyran, 3-methylnaphtho-(3-methoxybenzo)spiropyran and 3-propylspirobenzopyran.

These dye precursors may be used singly or may be used as a mixture containing at least two members of them as required.

Although not specially limited, the electron-accepting compound for use in the thermal recording material can be selected from those acidic substances which are generally used in thermal recording materials or pressure-sensitive recording materials. For example, the electron-accepting compound can be selected from clay substances, phenol derivatives, aromatic carboxylic acid derivatives, urea derivatives such as N,N′-diallylthiourea derivatives and N-sulfonylurea, or metal salts of these.

Specific examples of the above compound include clay substances such as activated clay, zeolite and bentonite, phenolic compounds such as 4-phenylphenol, 4-tert-butylphenol, 4-hydroxyacetophenone, 2,2′-dihydroxydiphenyl, 2,2′-methylenebis(4-methyl-6-tert-butylphenol), 4,4′-ethylenebis(2-methylphenol), 1,1-bis(4-hydroxyphenyl)propane, 1,1-bis(4-hydoxyphenyl)-pentane, 1,1-bis(4-hydroxyphenyl)hexane, 1,1-bis(4-hydroxyphenyl)cyclohexane, 2,2-bis(4-hydroxyphenyl)propane, 2,2-bis(4-hydroxyphenyl)hexane, 2,2-bis(4-hydroxyphenyl)-3-ethylhexane, 2,2-bis(3-chloro-4-hydroxyphenyl)-propane, 1,1-bis(4-hydroxyphenyl)-1-phenylethane, 1,1-bis(4-hydroxyphenyl)-1-phenylpropane, 4,4′-dihydroxydiphenyl ether, 4,4′-cyclohexylidenebis(2-isopropylphenol), 4,4′-dihydroxydiphenylsulfone, 2,4′-dihydroxydiphenylsulfone, 4-hydroxy-4′-methyldiphenylsulfone, 4-hydroxy-4′-isopropoxydiphenylsulfone, 4-hydroxy-4′-n-propoxydiphenylsulfone, 4-hydroxy-4′-benzyloxydiphenylsulfone, bis(3-allyl-4-hydroxyphenyl)sulfone, bis(3-chloro-4-hydroxyphenyl)sulfone, 2,4-bis(phenylsulfonyl)-phenol, bis(3-chloro-4-hydroxyphenyl)sulfide, 4,4′-thiobis(2-tert-butyl-5-methylphenol), 2,2′-bis(4-hydroxyphenylthio)diethyl ether, 1,7-di(4-hydroxyphenylthio)-3,5-dioxaheptane, dimethyl 4-hydroxypthalate, 2,2-bis(4-hydroxyphenyl)acetic esters, alkyl gallic esters, salicylanilide, 5-chlorosalicylanilide, a novolak type phenolic resin and a modified terpene phenolic resin, hydroxybenzoic esters such as ethyl 4-hydroxybenzoate, propyl 4-hydroxybenzoate, butyl 4-hydroxybenzoate, benzyl 4-hydroxybenzoate and chlorobenzyl 4-hydroxybenzoate, organic acids such as benzoic acid, salicylic acid, 1-hydroxy-2-naphthoic acid, 2-hydroxy-6-naphthoic acid, 3-isopropylsalicylic acid, 3-cyclohexylsalicylic acid, 5-cyclohexylsalicylic acid, 3,5-di-tert-butylsalicylic acid, 3,5-di-tert-nonylsalicylic acid, 3,5-didodecylsalicylic acid, 3-methyl-5-tert-dodecylsalicylic acid, 3,5-bis(α,α-dimethylbenzyl)salicylic acid, 3-methyl-5-(α-methylbenzyl)salicylic acid, 4-n-octyloxycarbonyl-aminosalicylic acid, 4-{2-(4-methoxyphenoxy)-ethoxy}salicylic acid, tartaric acid, oxalic acid, boric acid, citric acid and stearic acid, metal salts of these such as zinc, nickel, aluminum or calcium salts of these, urea derivatives such as bis{4-(4-methylphenyl)-sulfonylaminocarbonylaminophenyl}methane, and known compounds such as thiourea derivatives. These compounds may be used singly or may be used as a mixture containing two or more members of them as required.

The thermal recording layer constituting the thermal recording material of the present invention may contain a heat-fusible compound for improving the thermal response thereof. Although the heat-fusible compound is not specially limited, it preferably has a melting point of 60° C. to 180° C., particularly preferably 80° C. to 140° C.

Specific examples of the above heat-fusible compound include fatty acid amides such as stearic acid amide, N-hydroxymethylstearic acid amide, N-stearylstearic acid amide, ethylenebisstearic acid amide, oleic acid amide, palmitic acid amide, methylenebis hydrogenated tallow fatty acid amide and ricinoleic acid amide, synthetic and natural waxes such as paraffin wax, microcrystalline wax, polyethylene wax and carnauba wax, aliphatic urea compounds such as N-stearylurea, ether compounds such as 2-benzyloxynaphthalene, bis(4-methoxyphenyl)ether, 2,2′-bis(4-methoxyphenoxy) diethyl ether, 1,2-bis(3-methylphenoxy)ethane, 1,2-bis(phenoxymethyl)benzene, a naphthyl ether derivative, an anthryl ether derivative and an aliphatic ether, ester compounds such as diphenyl adipate, di(4-methylbenzyl)oxalate, dibenzyl oxalate, di(4-chlorobenzyl)oxalate, diphenyl carbonate, dimethyl terephthalate, dibenzyl terephthalate, phenyl benzenesulfonate and 4-acetylacetophenone, biphenyl derivatives such as m-terphenyl, 4-benzylbiphenyl, 4-acetylbiphenyl, 4-allyloxybiphenyl, and known heat-fusible compounds such as bis(4-allyloxyphenyl)sulfone, acetoacetic acid anilide, 4-methylacetoanilide and fatty acid anilides. These heat-fusible compounds may be used singly or may be used as a mixture containing two or more members of them as required.

The amount of the heat-fusible compound by mass ratio is in the range of 0.3 to 2 times as large as the above electron-accepting compound, more preferably in the range of 0.5 to 1.5 times as large. When it is in the above range, there can be obtained a thermal recording material excellent in basic properties such as thermal response, saturation density of a color-developed image, whiteness of a ground, and the like.

In addition, as a pigment in the thermal recording layer, there may be used inorganic pigments such as diatomite, talc, kaolin, calcined kaolin, heavy calcium carbonate, precipitated calcium carbonate, magnesium carbonate, zinc oxide, aluminum oxide, aluminum hydroxide, magnesium hydroxide, titanium dioxide, barium sulfate, zinc sulfate, amorphous silica, amorphous calcium silicate and colloidal silica, and organic pigments such as a melamine resin filler, a urea-formalin resin filler, a polyethylene powder and a nylon powder.

As other additives to the thermal recording layer, for preventing the wearing of a hot printing head or preventing the sticking, there may be used higher fatty acid metal salts such as zinc stearate and calcium stearate, waxes such as paraffin, paraffin oxide, polyethylene, polyethylene oxide, stearic acid amide and castor wax, dispersing agents such as sodium dioctylsulfosuccinate, ultraviolet absorbents such as benzophenone- and benzotriazole-containing ultraviolet absorbents, a surfactant and a fluorescence dye as required.

For the thermal recording layer for constituting the thermal recording material of the present invention, various water-soluble resins or water-dispersible resins may be used as a binder.

Although not specially limited, examples of the above high-molecular-weight resins include starches, cellulose derivatives such as hydroxymethylcellulose, methylcellulose, ethylcellulose and carboxymethylcellulose, proteins such as gelatin and casein, water-soluble binders such as polyvinyl alcohol, modified polyvinyl alcohol, sodium alginate, polyvinylpyrrolidone, polyacrylamide, an acrylamide/acrylic ester copolymer, an acrylamide/acrylic ester/methacrylic acid terpolymer, an alkali salt of polyacrylic acid, an alkali salt of polymaleic acid, an alkali salt of a styrene/maleic acid anhydride copolymer, an alkali salt of an ethylene/maleic acid anhydride copolymer and an alkali salt of an isobutylene/maleic acid anhydride copolymer, and water-dispersible binders such as a styrene/butadiene copolymer, an acrylonitrile/butadiene copolymer, a methyl acrylate/butadiene copolymer, an acrylonitrile/butadiene/styrene terpolymer, polyvinyl acetate, a vinyl acetate/acrylic ester copolymer, an ethylene/vinyl acetate copolymer, polyacrylic ester, a styrene/acrylic ester copolymer and polyurethane. These binders may be used singly or may be used as a mixture containing at least two members of them as required.

The color-developing components such as the dye precursor, the electron-accepting compound, etc., and the additives such as the heat-fusible compound, the pigment, the binder, etc., which are to be contained in the thermal recording layer, are applied to a support in the form of a dispersion of them in a dispersing medium, and dried. The above dispersion is obtained by a method in which the color-developing components and the other additive components are dry-milled and dispersed in a dispersing medium or a method in which the color-developing components and the other additive components are mixed with a dispersing agent and wet-milled.

The average particle diameter of those compounds which constitute the color-developing components in the above dispersion is generally 7 μm or less, preferably 0.05 to 5 μm, more preferably 0.1 to 2 μm. When it is in the above range, there can be obtained a thermal recording material excellent in the transparency and color developability of the thermal recording layer.

The coating amount of the thermal recording layer as a solid coating amount of the dye precursor is generally 0.1 to 2 g/m², more preferably 0.15 to 1.5 g/m². When it is in the above range, sufficient color-development sensitivity can be obtained without any disadvantage in economic performance.

The thermal recording material of the present invention may be provided with at least one undercoat layer formed of one or more pigments and a binder between the support and the thermal recording layer as required. When the thermal recording material of the present invention is provided with the undercoat layer, the coating amount of the undercoat layer is preferably 1 to 30 g/m², more preferably 3 to 20 g/m².

Although not specially limited, the pigment for the undercoat layer can be selected from inorganic pigments such as calcined kaolin, diatomite, talc, kaolin, heavy calcium carbonate, precipitated calcium carbonate, magnesium carbonate, zinc oxide, aluminum oxide, aluminum hydroxide, magnesium hydroxide, titanium dioxide, barium sulfate, zinc sulfate, amorphous silica, amorphous calcium silicate and colloidal silica, and organic pigments such as a melamine resin filler, a urea-formalin resin filler, a polyethylene powder and a nylon powder. Organic spherical particles and organic hollow particles can be also used. Calcined kaolin is preferred.

The binder for the undercoat layer can be selected from various water-soluble and water-dispersible resins. Specific examples thereof include those binders which are described as specific examples of the binder for use in the above thermal recording layer. The binders may be used singly or may be used as a mixture containing at least two members of them.

In the present invention, paper is mainly used as the support. Besides the paper, the support can be selected from various woven fabrics, non-woven fabrics, synthetic resin films, synthetic resin laminated papers, synthetic papers, metal foils, vapor-deposited sheets or composite sheets combining these by laminating, as required.

The thermal recording material of the present invention can be obtained by forming the undercoat layer on the support as required and then consecutively forming the thermal recording layer and the protective layer.

The method of forming the protective layer, the thermal recording layer or the undercoat layer is not specially limited, and these layers can be formed according to conventionally known techniques. As a specific example, the coating liquid is applied by a method such as air knife coating, rod blade coating, bar coating, blade coating, gravure coating, curtain coating, or E bar coating, and the applied coating liquid is dried to form the protective layer, the thermal recording layer or the undercoat layer.

Further, each of the thermal recording layer, the protective layer, etc., can be formed by various printing machines according to a method of lithography, letterpress, flexography, gravure, screen or hot melt.

Further, after the application to form the undercoat layer, after the application to form the thermal recording layer or after the application to form the protective layer, super calendering may be carried out to improve image qualities.

While the thermal recording material of the present invention is applied to offset printing, it can be applied particularly to lithographic offset printing in which printing is carried out using a dampening solution and utilizing a repulsion between water and an oil (ink).

The present invention will be explained with reference to Examples hereinafter, while the present invention shall not be limited by these Examples. In the following Examples and Comparative Examples, evaluations were made for a transfer amount of water by the Bristow method, contact angles, center plane average roughness (SRa), offset printability, surface strength and thermal printing color developability by the following methods. In samples used in Examples and Comparative Examples, “%” and “part” are all based on mass standard, and application amounts stand for absolute dry application amounts.

[Measurement for Transfer Amount of Water by Bristow Method]

In an atmosphere of 23° C. and 50% RH, a measurement was made for a transfer amount of water on a protective layer for a contact time period of 150 ms using a head box having a 0.5 mm wide slit, to which a 30 μl of a 0.1% kayafect red B (direct dye supplied by NIPPON KAYAKU CO., LTD.) aqueous solution was injected, with a Bristow tester supplied by Toyo Seiki Seisaku-sho, Ltd.

[Measurement of Contact Angle]

A distilled water droplet was dropped on a protective layer surface, and after 1 second, the water droplet was measured for a contact angle with a FACE automatic contact angle meter CA-Z model supplied by KYOWA INTERFACE SCIENCE CO., LTD.

[Measurement of Center Plane Average Roughness (SRa)]

Determined with an SE-3AK model machine and an SPA-11 model machine supplied by Kosaka Laboratory Ltd., as a stylus type three-dimensional surface roughness tester, at a cutoff value of 0.8 mm with Wx=20 mm and Wy=8 mm, i.e., under the conditions of Sa=160 mm². In the data processing in the X-axis direction, sampling was made in 500 points, and scanning of 17 lines or more in the Y-axis direction was carried out (unit: μm).

[Offset Printability]

A thermal recording material was evaluated for offset printability with an RI testing machine supplied by Akira Seisakusho Co., Ltd. The surface of a thermal recording material was thinly wetted with water, and printing was carried out using 0.4 cc of Trans G Indigo Normal (supplied by Dainippon Ink & Chemicals, Inc.) as ink. A state where the ink adhered thereto was visually evaluated. The visual valuation of the ink-adhering state was made on the basis of the following ratings.

1. The ink adherence is very good, and a thermal recording material has excellent offset printability.

2. The ink adherence is good, and a thermal recording material has good offset printability.

3. The ink adherence is good, and a thermal recording material has no practical problem in offset printing.

4. The ink adherence is poor, and a thermal recording material has a practical problem in offset printing.

5. Almost no ink adheres, and a thermal recording material is practically not feasible for offset printing.

[Surface Strength]

A thermal recording material was evaluated for surface strength with an RI testing machine supplied by Akira Seisakusho Co., Ltd. Printing was made on the surface of a thermal recording material several times with a tackiness No. 10 blank ink, and the printed surface was visually evaluated for a picking (peeling of the thermal recording material surface). The visual valuation was made on the basis of the following ratings.

1. Almost no peeling is found.

2. Peeling is found to a slight extent, but there is no problem in practical use.

3. Peeling is found to some extent, but there is no problem in practical use.

4. Peeling is found to a great extent, and there is a problem in practical use.

5. Peeling is found to a very great extent, and a thermal recording material is not acceptable in practical use.

[Color Developability in Thermal Printing]

A printing test was carried out with a facsimile tester TH-PMD supplied by Okura Electric Co., Ltd. A thermal head having a dot density of 8 dots/mm and a head resistance of 1,681 Ω was used, and printing was carried out by electrically powering at a head voltage of 21 V at a pulse width of 1.4 msec. A printing was measured for an optical density with a Macbeth RD-918 reflection densitometer. The larger the value is, the superior in color developability in thermal printing, and the optical density is preferably at least 0.7 in practical use.

<Preparation of Dispersion for Thermal Recording Layer and Dispersion for Protective Layer>

Dispersions A, B, C and D for thermal recording layers and Dispersions 1, 2 and 3 for protective layers used in Examples and Comparative Examples were prepared by the following methods.

(Dispersion for Thermal Recording Layer)

(Dispersion A)

200 Grams of 3-(N,N-dibutylamino)-6-methyl-7-anilinofluorane as a dye precursor was dispersed in a mixture of 200 g of a 10% polyvinyl alcohol aqueous solution with 600 g of water, and the dispersion was milled with a bead mill until an average particle diameter of 1 μm was attained, to give Dispersion A.

(Dispersion B)

400 Grams of 2,2-bis(4-hydroxyphenyl)-propane as an electron-accepting compound was dispersed in a mixture of 400 g of a 10% polyvinyl alcohol aqueous solution with 200 g of water, and the dispersion was milled with a bead mill until an average particle diameter of 1 μm was attained, to give Dispersion B.

(Dispersion C)

400 Grams of 2-benzyloxynaphthalene as a heat-fusible compound was dispersed in a mixture of 400 g of a 10% polyvinyl alcohol aqueous solution with 200 g of water, and the dispersion was milled with a bead mill until an average particle diameter of 1 μm was attained, to give Dispersion C.

(Dispersion D)

200 Grams of calcium carbonate (Brilliant 15, supplied by Shiraishi Kogyo K.K.) as a pigment was mixed with 800 g of a 0.5% sodium polyacrylate aqueous solution and dispersed therein with a homomixer for 10 minutes, to give Dispersion D.

(Preparation of Dispersion for Protective Layer)

(Dispersion 1) 100 Grams of amorphous silica (Mizukasil P-707, supplied by Mizusawa Industrial Chemicals, Ltd.) having an oil absorption, measured according to JIS-K-5101, of 260 ml/100 g was mixed with 900 g of a 0.5% sodium polyacrylate aqueous solution and dispersed therein with a homomixer for 10 minutes, to give Dispersion 1.

(Dispersion 2)

200 Grams of calcium carbonate (Callite, supplied by Shiraishi Kogyo K.K.) having an oil absorption, measured according to JIS-K-5101, of 90 ml/100 g was mixed with 800 g of a 0.5% sodium polyacrylate aqueous solution and dispersed therein with a homomixer for 10 minutes, to give Dispersion 2.

(Dispersion 3)

Grams of amorphous silica (Mizukasil P-603, supplied by Mizusawa Industrial Chemicals, Ltd.) having an oil absorption, measured according to JIS-K-5101, of 115 ml/100 g was mixed with 900 g of a 0.5% sodium polyacrylate aqueous solution and dispersed therein with a homomixer for 10 minutes, to give Dispersion 3.

### EXAMPLE 1

(A) Preparation of Thermal Coating Paper

A wood-free paper having a basis weight of 40 g/m² was provided as a support, and an under sheet layer coating liquid having the following formulation was air-knife coated thereon so as to attain a solid coating amount of 9 g/m² and dried, to prepare a thermal coating paper.

| | |
|---|---|
| Calcined kaolin (Ansilex supplied by | 100 parts |
| Engelhard Corporation) | |
| 50% Styrene-butadiene latex aqueous | 24 parts |
| dispersion | |
| Water | 200 parts |

(B) Preparation of Thermal Recording Layer Coating Liquid

Dispersions A to D were used, and these and materials were mixed in amounts shown below, and the mixture was fully stirred to prepare a thermal recording layer coating liquid.

| | |
|---|---|
| Dispersion A | 20 parts |
| Dispersion B | 15 parts |
| Dispersion C | 15 parts |
| Dispersion D | 25 parts |
| 10% Polyvinyl alcohol (Aqueous solution of | 30 parts |
| GM-14L supplied by Nippon Synthetic Chemical | |
| Industry Co., Ltd.) aqueous solution | |
| Water | 30 parts |

(C) Preparation of Protective Layer Coating Liquid

A water-dispersible core-shell type acrylic emulsion having a solid content of 20% and having a core that was formed of acrylonitrile as an essential component and had a glass transition temperature (Tg) of −12° C. and a shell that was formed of acrylamide as an essential component and had a glass transition temperature (Tg) of 205° C. (this will be referred to as “20% core-shell type acrylic emulsion (Z)” hereinafter) and materials were mixed in amounts shown below, and the mixture was fully stirred to prepare a protective layer coating liquid. Table 1 also shows the composition of the protective layer.

| | |
|---|---|
| 20% Core-shell type acrylic emulsion (Z) | 50 parts |
| Dispersion 1 | 150 parts |
| 40% Zinc stearate aqueous solution | 6 parts |
| Water | 250 parts |

(Preparation of Thermal Recording Material)

The thermal recording layer coating liquid prepared in (B) was air-knife coated on the thermal coating paper prepared in (A) so as to obtain a dye precursor coating amount of 0.3 g/m², and the thus-coated coating liquid was dried. Then, the protective layer coating liquid prepared in (C) was air-knife coated on the thermal recording layer so as to obtain a coating amount of 5 g/m², and the thus-coated coating liquid was dried, followed by super calendering, to give a thermal recording material.

The thermal recording material obtained by the above method was measured for a transfer amount of water according to the Bristow method, a contact angle with the water, a center plane average roughness (SRa) and offset printability. Table 2 shows the results.

### EXAMPLE 2

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 20% Core-shell type acrylic emulsion (Z) | 25 parts |
| Dispersion 2 | 75 parts |
| 40% Zinc stearate aqueous solution | 6 parts |
| Water | 270 parts |

### EXAMPLE 3

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 20% Core-shell type acrylic emulsion (Z) | 25 parts |
| 10% Completely saponified polyvinyl | 50 parts |
| alcohol (aqueous solution of NL-05 supplied by | |
| Nippon Synthetic Chemical Industry Co., Ltd.) | |
| Dispersion 2 | 50 parts |
| 40% Zinc stearate aqueous solution | 6 parts |
| Water | 240 parts |

### COMPARATIVE EXAMPLE 1

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 15% Polyacrylamide resin (HARICOAT BI-736, | 67 parts |
| supplied by Harima Chemicals, Inc.) | |
| Dispersion 2 | 25 parts |
| 40% Zinc stearate aqueous solution | 6 parts |
| Water | 190 parts |

### COMPARATIVE EXAMPLE 2

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 20% Core-shell type acrylic emulsion (Z) | 25 parts |
| 10% Completely saponified polyvinyl | 50 parts |
| alcohol (aqueous solution of NL-05 supplied by | |
| Nippon Synthetic Chemical Industry Co., Ltd.) | |
| Dispersion 2 | 25 parts |
| 40% Zinc stearate aqueous solution | 6 parts |
| Water | 185 parts |

### COMPARATIVE EXAMPLE 3

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 20% Core-shell type acrylic emulsion (Z) | 50 parts |
| Dispersion 1 | 50 parts |
| 40% Zinc stearate aqueous solution | 6 parts |
| Water | 185 parts |

### COMPARATIVE EXAMPLE 4

A thermal recording material was obtained in the same manner as in Example 1 except that the following formulation was used as a protective layer coating liquid. Table 1 shows the composition of the protective layer coating liquid, and Table 2 shows evaluation results of the obtained thermal recording material.

| | |
|---|---|
| 15% Polyacrylamide resin (HARICOAT BI-736, | 67 parts |
| supplied by Harima Chemicals, Inc.) | |
| Dispersion 1 | 10 parts |
| 40% Zinc stearate aqueous solution | 6 parts |
| Water | 210 parts |

TABLE 1
Composition of protective layer (part)

| | Water | | | | | | | | | | | Sticking | | |
|---|---|---|---|---|---|---|---|---|---|---|---|---|---|---|
| | dis- | | | | | | | | | | | | | |
| | pers- | | | | | | | | | | | | | |
| | ible | | | | Water-soluble | | | preventing | | | | | | |
| | resin | Water-soluble resin | | | resin + pigment | | | Crosslinking agent | | | | liquid | | Other |
| | | | | | | | High- | High- | | | | | | |
| 20% | 10% | mol- | mol- | Low- | | | | | | | | | | |
| Core | Com- | | 10% | | | | ecular- | ecular- | mol- | Low- | | | | |
| shell | pletely | | Silicon- | | | | weight | weight | ecular- | ecular- | Disper- | | | |
| type | saponi- | 15% | modi- | | | | type | type | weight | weight | sion | | | |
| acrylic | fied | Pol- | fied | Dis- | Dis- | Dis- | (poly- | (modi- | type | type | of 40% | | | |
| emul- | poly- | acryla- | poly- | per- | per- | per- | amide | fied | (alde- | (guana- | zinc | | | |
| sion | vinyl | mide | vinyl | sion | sion | sion | amine- | amine | hyde | mine | stearate | | Coating | |
| (Z) | alcohol | resin | alcohol | 1 | 2 | 3 | based) | based) | group) | group | in water | Water | amount | |
| Example 1 | 50 | | | | 150 | | | | | | | 6 | 250 | 5 g/m² |
| Example 2 | 25 | | | | | 75 | | | | | | 6 | 270 | ↑ |
| Example 3 | 25 | 50 | | | | 50 | | | | | | 6 | 240 | ↑ |
| Compara- | | | 67 | | | 25 | | | | | | 6 | 190 | ↑ |
| tive | | | | | | | | | | | | | | |
| Example 1 | | | | | | | | | | | | | | |
| Compara- | 25 | 50 | | | | 25 | | | | | | 6 | 185 | ↑ |
| tive | | | | | | | | | | | | | | |
| Example 2 | | | | | | | | | | | | | | |
| Compara- | 50 | | | | 50 | | | | | | | 6 | 185 | ↑ |
| tive | | | | | | | | | | | | | | |
| Example 3 | | | | | | | | | | | | | | |
| Compara- | | | 67 | | 10 | | | | | | | 6 | 210 | ↑ |
| tive | | | | | | | | | | | | | | |
| Example 4 | | | | | | | | | | | | | | |
| Example 4 | the same components as those in Example 1 | | | | | | | | | | | | | 2 g/m² |
| Example 5 | the same components as those in Example 2 | | | | | | | | | | | | | ↑ |
| Example 6 | the same components as those in Example 3 | | | | | | | | | | | | | ↑ |
| Example 7 | | 100 | | | 150 | | | | | | | 6 | 200 | ↑ |
| Compara- | the same components as those in Comparative Example 2 | | | | | | | | | | | | | ↑ |
| tive | | | | | | | | | | | | | | |
| Example 5 | | | | | | | | | | | | | | |
| Compara- | the same components as those in Comparative Example 2 | | | | | | | | | | | | | ↑ |
| tive | | | | | | | | | | | | | | |
| Example 6 | | | | | | | | | | | | | | |
| Compara- | the same components as those in Comparative Example 2 | | | | | | | | | | | | | ↑ |
| tive | | | | | | | | | | | | | | |
| Example 7 | | | | | | | | | | | | | | |
| Compara- | the same components as those in Comparative Example 2 | | | | | | | | | | | | | ↑ |
| tive | | | | | | | | | | | | | | |
| Example 8 | | | | | | | | | | | | | | |
| Compara- | 50 | | | | 10 | | | | | | | 6 | 157 | ↑ |
| tive | | | | | | | | | | | | | | |
| Example 9 | | | | | | | | | | | | | | |
| Compara- | 50 | | | | 350 | | | | | | | 6 | 384 | ↑ |
| tive | | | | | | | | | | | | | | |
| Example | | | | | | | | | | | | | | |
| 10 | | | | | | | | | | | | | | |
| Compara- | | 25 | | | 200 | | | 1 | | | | 12.5 | 224 | 0.5 g/m² |
| tive | | | | | | | | | | | | | | |
| Example | | | | | | | | | | | | | | |
| 11 | | | | | | | | | | | | | | |
| Compara- | 50 | 400 | | | | | 400 | | | | | 25 | 791 | 2 g/m² |
| tive | | | | | | | | | | | | | | |
| Example | | | | | | | | | | | | | | |
| 12 | | | | | | | | | | | | | | |

TABLE 2

| | Transfer | | | | |
|---|---|---|---|---|---|
| | amount of | | Center | | |
| | water | | plane | | |
| | according | | average | Oil | |
| | to | | rough- | absorp- | |
| | Bristow | Contact | ness | tion of | Offset |
| | method | angle | (SRa) | pigment | print- |
| | (ml/m²) | (° C.) | (μm) | (ml/100 g) | ability |
| Ex. 1 | 8.4 | 72.2 | 0.72 | 260 | 1 |
| Ex. 2 | 7.1 | 62.3 | 0.61 | 90 | 2 |
| Ex. 3 | 9.1 | 75.6 | 0.58 | 90 | 3 |
| CEx. 1 | 2.8 | 47.6 | 0.51 | 90 | 5 |
| CEx. 2 | 2.8 | 58.9 | 0.61 | 90 | 4 |
| CEx. 3 | 2.4 | 54.3 | 0.66 | 260 | 4 |
| CEx. 4 | 2.0 | 45.0 | 0.49 | 260 | 5 |

As is clear from Tables 1 and 2, when Examples 1 to 3 and Comparative Examples 1 to 4 are compared, it is seen that a thermal recording material having a thermal recording layer and a protective layer formed consecutively is improved in offset printability by adjusting the transfer amount of water on the protective layer surface for a contact time of 150 ms according to the Bristow method to 3 ml/m²-15 ml/m² and adjusting the contact angle of the protective layer surface and water to 60°-100°.

Further, when Examples 1 and 2 and Example 3 are compared, it is seen that the thermal recording material is improved in offset printability by adjusting the center plane average roughness (SRa) in a coating direction at a cutoff value of 0.8 mm, measured with a stylus type three-dimensional surface roughness tester, to 0.6 μm-2 μm. Further, when Examples 1 and 2 are compared, it is seen that there is produced an effect that the thermal recording material is more improved in offset printability by incorporating a pigment component having an oil absorption, measured according to JIS-K-5101, of 200 ml/100 g -350 ml/100 g into the protective layer.

### EXAMPLE 4

A thermal recording material was obtained in the same manner as in Example 1 except that the protective layer coating liquid prepared in (C) of Example 1 was air-knife coated on the thermal recording layer so as to obtain a coating amount of 2 g/m² followed by drying and super calendering.

Table 1 shows the composition of the protective layer coating liquid, and Table 3 shows evaluation results. In this Example and Examples and Comparative Examples thereafter, thermal recording materials were evaluated for surface strength and color developability in thermal printing in addition to the evaluations thereof for transfer amounts of water according to the Bristow method, contact angles, center plane average roughness, oil absorptions of pigments and offset printability.

### EXAMPLE 5

A thermal recording material was obtained in the same manner as in Example 4 except that the formulation in Example 2 was used as a protective layer coating liquid. Table 1 shows the composition of the protective layer coating liquid, and Table 3 shows the evaluation results of the obtained thermal recording material.

### EXAMPLE 6

A thermal recording material was obtained in the same manner as in Example 4 except that the formulation in Example 3 was used as a protective layer coating liquid. Table 1 shows the composition of the protective layer coating liquid, and Table 3 shows the evaluation results of the obtained thermal recording material.

### EXAMPLE 7

A thermal recording material was obtained in the same manner as in Example 4 except that the following formulation was used as a protective layer coating liquid. Table 1 shows the composition of the protective layer coating liquid, and Table 3 shows the evaluation results of the thermal recording material.

| | |
|---|---|
| 10% Completely saponified polyvinyl | 100 parts |
| alcohol (aqueous solution of NL-05 supplied by | |
| Nippon Synthetic Chemical Industry Co., Ltd.) | |
| Dispersion 1 | 150 parts |
| 40% Zinc stearate aqueous solution | 6 parts |
| Water | 200 parts |

### COMPARATIVE EXAMPLE 5

A thermal recording material was obtained in the same manner as in Example 4 except that the formulation in Comparative Example 1 was used as a protective layer coating liquid. Table 1 shows the composition of the protective layer coating liquid, and Table 3 shows the evaluation results of the obtained thermal recording material.

### COMPARATIVE EXAMPLE 6

A thermal recording material was obtained in the same manner as in Example 4 except that the formulation in Comparative Example 2 was used as a protective layer coating liquid. Table 1 shows the composition of the protective layer coating liquid, and Table 3 shows the evaluation results of the obtained thermal recording material.

### COMPARATIVE EXAMPLE 7

A thermal recording material was obtained in the same manner as in Example 4 except that the formulation in Comparative Example 3 was used as a protective layer coating liquid. Table 1 shows the composition of the protective layer coating liquid, and Table 3 shows the evaluation results of the obtained thermal recording material.

### COMPARATIVE EXAMPLE 8

A thermal recording material was obtained in the same manner as in Example 4 except that the formulation in Comparative Example 4 was used as a protective layer coating liquid. Table 1 shows the composition of the protective layer coating liquid, and Table 3 shows the evaluation results of the obtained thermal recording material.

### COMPARATIVE EXAMPLE 9

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 20% Core-shell type acrylic emulsion (Z) | 50 parts |
| Dispersion 1 | 10 parts |
| 40% Zinc stearate aqueous solution | 6 parts |
| Water | 157 parts |

### COMPARATIVE EXAMPLE 10

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 20% Core-shell type acrylic emulsion (Z) | 50 parts |
| Dispersion 1 | 350 parts |
| 40% Zinc stearate aqueous solution | 6 parts |
| Water | 384 parts |

### COMPARATIVE EXAMPLE 11

A thermal recording material was obtained in the same manner as in Example 1 except that the following formulation was used as a protective layer coating liquid and that the thus-prepared protective layer coating liquid was air-knife coated on the thermal recording layer so as to obtain a coating amount of 0.5 g/m² followed by drying and super calendering. Table 1 shows the composition of the protective layer coating liquid, and Table 3 shows the evaluation results of the obtained thermal recording material.

| | | |
|---|---|---|
| 10% Completely saponified polyvinyl | 25 | parts |
| alcohol (aqueous solution of NL-5 supplied by | | |
| Nippon Synthetic Chemical Industry Co., Ltd.) | | |
| Dispersion 1 | 200 | parts |
| High-molecular-weight crosslinking agent | 1 | part |
| containing polyamideamine as a main chain (25%) | | |
| (WS-547, supplied by Nippon PMC Co., Ltd.) | | |
| 40% Zinc stearate aqueous solution | 12.5 | parts |
| Water | 224 | parts |

### COMPARATIVE EXAMPLE 12

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 10% Completely saponified polyvinyl | 400 parts |
| alcohol | |
| 20% Core-shell type acrylic emulsion (Z) | 50 parts |
| Dispersion 3 | 400 parts |
| 40% Zinc stearate aqueous solution | 25 parts |
| Water | 791 parts |

As is clear from Tables 1 and 3, when Examples 4 to 7 and Comparative Examples 5 to 12 are compared, it is seen that excellent offset printability and suitable surface strength can be obtained in a thermal recording material having a thermal recording layer and a protective layer formed consecutively by adjusting the transfer amount of water on the protective layer surface for a contact time of 150 ms according to the Bristow method to 3 ml/m²-15 ml/m² and adjusting the contact angle of the protective layer surface and water to 60°-100®.

Further, when Examples 5 and 6 are compared, it is seen that the thermal recording material is improved in offset printability by adjusting the center plane average roughness (SRa) in a coating direction at a cutoff value of 0.8 mm, measured with a stylus type three-dimensional surface roughness tester, to 0.6 μm or more. Further, when Examples 4 and 5 are compared, it is seen that the thermal recording material is more improved in offset printability by incorporating a pigment component having an oil absorption, measured according to JIS-K-5101, of 200 ml/100 g or more into the protective layer.

Example 7 is a case where the water-dispersible resin in Example 4 was replaced by the completely saponified polyvinyl alcohol, and the thermal recording material in Example 7 exhibited nearly similar properties. When evaluated visually closely, the thermal recording material in Example 4 was superior in offset printability and surface strength to some extent.

### EXAMPLE 8

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 2 | 25 | parts |
| 40% Zinc stearate aqueous solution | 6 | parts |
| High-molecular-weight crosslinking agent | 4 | parts |
| having a glycidyl group containing polyamideamine | | |
| as a main chain (25%) (WS-547, supplied by Nippon | | |
| PMC Co., Ltd.) | | |
| Low-molecular-weight crosslinking agent | 2 | parts |
| having an aldehyde group (40%) (glyoxal) | | |
| Water | 210 | parts |

### EXAMPLE 9

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 2 | 25 | parts |
| 40% Zinc stearate aqueous solution | 6 | parts |
| High-molecular-weight crosslinking agent | 2 | parts |
| having a glycidyl group and containing | | |
| polyamideamine as a main chain (25%) (WS-547, | | |
| supplied by Nippon PMC Co., Ltd.) | | |
| Low-molecular-weight crosslinking agent | 2 | parts |
| having an aldehyde group (40%) (glyoxal) | | |
| Water | 210 | parts |

### EXAMPLE 10

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 1 | 50 | parts |
| 40% Zinc stearate aqueous solution | 6 | parts |
| High-molecular-weight crosslinking agent | 2 | parts |
| having a glycidyl group and containing | | |
| polyamideamine as a main chain (25%) (WS-547, | | |
| supplied by Nippon PMC Co., Ltd.) | | |
| Low-molecular-weight crosslinking agent | 2 | parts |
| having an aldehyde group (40%) (glyoxal) | | |
| Water | 185 | parts |

### EXAMPLE 11

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 2 | 25 | parts |
| 40% Zinc stearate aqueous solution | 6 | parts |
| High-molecular-weight crosslinking agent | 2.2 | parts |
| containing a modified amine resin as a main | | |
| component (45%) (Sumirez Resin SPI-102A, supplied | | |
| by Sumitomo Chemical Co., Ltd.) | | |
| Low-molecular-weight crosslinking agent | 2 | parts |
| having an aldehyde group (40%) (glyoxal) | | |
| Water | 218 | parts |

### EXAMPLE 12

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 1 | 50 | parts |
| 40% Zinc stearate aqueous solution | 6 | parts |
| High-molecular-weight crosslinking agent | 2 | parts |
| having a glycidyl group and containing | | |
| polyamideamine as a main chain (25%) (WS-547, | | |
| supplied by Nippon PMC Co., Ltd.) | | |
| Low-molecular-weight crosslinking agent | 0.8 | part |
| having a guanamine group (100%) (Acetoguanamine) | | |
| Water | 189 | parts |

### EXAMPLE 13

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | | |
|---|---|---|
| 10% Silicon-modified polyvinyl alcohol | 150 | parts |
| (R1130, supplied by Shin-Etsu Chemical Co., Ltd.) | | |
| Dispersion 1 | 50 | parts |
| 40% Zinc stearate aqueous solution | 6 | parts |
| High-molecular-weight crosslinking agent | 10 | parts |
| having a glycidyl group and containing | | |
| polyamideamine as a main chain (25%) (WS-547, | | |
| supplied by Nippon PMC Co., Ltd.) | | |
| Low-molecular-weight crosslinking agent | 2 | parts |
| having an aldehyde group (40%) (glyoxal) | | |
| Water | 210 | parts |

### EXAMPLE 14

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 10% Silicon-modified polyvinyl alcohol | 150 parts |
| (R1130, supplied by Shin-Etsu Chemical Co., Ltd.) | |
| Dispersion 1 | 50 parts |
| 40% Zinc stearate aqueous solution | 6 parts |
| High-molecular-weight crosslinking agent | 10 parts |
| having a glycidyl group and containing | |
| polyamideamine as a main chain (25%) (WS-547, | |
| supplied by Nippon PMC Co., Ltd.) | |
| Low-molecular-weight cross linking agent | 5 parts |
| having an aldehyde group (40%) (glyoxal) | |
| Water | 194 parts |

### COMPARATIVE EXAMPLE 13

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 10% Silicon-modified polyvinyl alcohol | 150 parts |
| (R1130, supplied by Shin-Etsu Chemical Co., Ltd.) | |
| Dispersion 2 | 25 parts |
| 40% Zinc stearate aqueous solution | 6 parts |
| Water | 192 parts |

### COMPARATIVE EXAMPLE 14

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 10% Silicon-modified polyvinyl alcohol | 150 parts |
| (R1130, supplied by Shin-Etsu Chemical Co., Ltd.) | |
| Dispersion 2 | 5 parts |
| 40% Zinc stearate aqueous solution | 6 parts |
| High-molecular-weight crosslinking agent | 2 parts |
| having a glycidyl group and containing | |
| polyamideamine as a main chain (25%) (WS-547, | |
| supplied by Nippon PMC Co., Ltd.) | |
| Low-molecular-weight cross linking agent | 2 parts |
| having an aldehyde group (40%) (glyoxal) | |
| Water | 163 parts |

### COMPARATIVE EXAMPLE 15

A thermal recording material was obtained in the same manner as in Example 4 except that the following formulation was used as a protective layer coating liquid. Table 1 shows the composition of the protective layer coating liquid, and Table 3 shows the evaluation results of the obtained thermal recording material.

| | |
|---|---|
| 10% Silicon-modified polyvinyl alcohol | 150 parts |
| (R1130, supplied by Shin-Etsu Chemical Co., Ltd.) | |
| Dispersion 2 | 150 parts |
| 40% Zinc stearate aqueous solution | 6 parts |
| High-molecular-weight crosslinking agent | 2 parts |
| having a glycidyl group and containing | |
| polyamideamine as a main chain (25%) (WS-547, | |
| supplied by Nippon PMC Co., Ltd.) | |
| Low-molecular-weight cross linking agent | 2 parts |
| having an aldehyde group (40%) (glyoxal) | |
| Water | 501 parts |

### EXAMPLE 15

A thermal recording material was obtained in the same manner as in Example 4 except that the coating of the protective layer coating liquid on the thermal recording layer and the drying thereof were not followed by the super calendering. Table 1 shows the composition of the protective layer coating liquid, and Table 3 shows the evaluation results of the obtained thermal recording material.

### EXAMPLE 16

A thermal recording material was obtained in the same manner as in Example 8 except that the coating of the protective layer coating liquid on the thermal recording layer and the drying thereof were not followed by the super calendering. Table 1 shows the composition of the protective layer coating liquid, and Table 3 shows the evaluation results of the obtained thermal recording material.

TABLE 3

| | Transfer | | | | | | |
|---|---|---|---|---|---|---|---|
| | amount of | | Center | | | | |
| | water | | plane | | | | Color |
| | according | | average | Oil | | | develop- |
| | to | | rough- | absorp- | | | ability |
| | Bristow | Contact | ness | tion of | Offset | | in |
| | method | angle | (SRa) | pigment | print- | | thermal |
| | (ml/m²) | (° C.) | (μm) | (ml/100 g) | ability | SS* | printing |
| Ex. 4 | 8.1 | 71.8 | 0.72 | 260 | 1 | 3 | 0.84 |
| Ex. 5 | 6.8 | 64.8 | 0.62 | 90 | 2 | 3 | 0.82 |
| Ex. 6 | 8.4 | 71.7 | 0.55 | 90 | 3 | 2 | 1.02 |
| Ex. 7 | 9.6 | 68.0 | 0.75 | 260 | 1 | 3 | 0.87 |
| CEx. 5 | 4.8 | 43 | 0.42 | 90 | 4 | 5 | 1.11 |
| CEx. 6 | 3.1 | 56.6 | 0.54 | 90 | 4 | 4 | 0.98 |
| CEx. 7 | 2.2 | 61 | 0.52 | 260 | 4 | 3 | 0.93 |
| CEx. 8 | 2.4 | 50.2 | 0.42 | 260 | 5 | 5 | 1.10 |
| CEx. 9 | 2.1 | 75.3 | 0.33 | 260 | 4 | 3 | 1.02 |
| CEx. 10 | 8.2 | 56.3 | 0.69 | 260 | 2 | 5 | 0.54 |
| CEx. 11 | 7.5 | 54.3 | 0.64 | 260 | 1 | 4 | 0.65 |
| CEx. 12 | 5.8 | 50.9 | 0.58 | 115 | 3 | 4 | 1.15 |
| Ex. 8 | 5.0 | 75.0 | 0.69 | 90 | 1 | 1 | 1.18 |
| Ex. 9 | 6.3 | 70.4 | 0.66 | 90 | 1 | 1 | 1.17 |
| Ex. 10 | 7.6 | 67.3 | 0.66 | 260 | 1 | 1 | 1.06 |
| Ex. 11 | 7.8 | 60.8 | 0.64 | 90 | 2 | 2 | 1.16 |
| Ex. 12 | 6.7 | 69.3 | 0.68 | 260 | 1 | 1 | 0.89 |
| Ex. 13 | 3.2 | 81.5 | 0.63 | 260 | 1 | 2 | 0.96 |
| Ex. 14 | 7.0 | 61.7 | 0.63 | 260 | 1 | 2 | 0.94 |
| CEx. 13 | 7.1 | 35.3 | 0.64 | 90 | 5 | 2 | 0.98 |
| CEx. 14 | 6.3 | 39.2 | 0.63 | 90 | 5 | 1 | 0.89 |
| CEx. 15 | 8.4 | 28.9 | 0.72 | 90 | 3 | 4 | 0.71 |
| Ex. 15 | 11.0 | 63.1 | 1.28 | 260 | 3 | 2 | 0.71 |
| Ex. 16 | 8.3 | 64.6 | 1.46 | 90 | 2 | 1 | 0.78 |

Ex. = Example, CEx. = Comparative Example
SS* = Surface strength

As is clear from Tables 1 and 3, when Example 9 and Example 11 are compared, it is seen that there is produced an effect that the offset printability is improved by using, as a resin in the protective layer, a silicon-modified polyvinyl alcohol and also using 2 mass % to 10 mass %, based on the solid content of the resin in the protective layer, of a high-molecular-weight crosslinking agent containing a glycidyl group and having a polyamideamine as a main chain and 2 mass % to 8 mass %, based on the solid content of the resin in the protective layer, of a low-molecular-weight crosslinking agent having an aldehyde group. Further, when Example 10 and Example 12 are compared, it is seen that the effect on the color developability in thermal printing differs between these two Examples even in a case where the offset printability and the surface strength are at similar levels.

In Examples 9 and 10, the ink adherence in the evaluation for the offset printability is rated at 1. In visual close evaluation, however, the ink adherence in Example 10 using a pigment having a high oil absorption was superior.

Further, when Example 9 is compared with Comparative Examples 14 and 15, it is seen that the offset printability is degraded when the surface contact angle is smaller than 60 degrees even if the protective layer contains, as a resin, the silicon-modified polyvinyl alcohol and also contains the high-molecular-weight crosslinking agent and the low-molecular-weight crosslinking agent.

Further, when Examples 4 and 15 are compared and when Examples 8 and 16 are compared, it is seen that the thermal recording materials having a center plane average roughness of smaller than 1 μm in Examples 4 and 8 have excellent offset printability over the thermal recording materials having a center plane average roughness of greater than 1 μm in Examples 15 and 16.

### EFFECT OF THE INVENTION

As is clear from the foregoing, in a thermal recording material having thermal recording layer formed on a support and a protective layer containing a pigment component and a resin, formed on the thermal recording layer, the transfer amount of water on the protective layer surface for a contact time period of 150 ms according to the Bristow method and the contact angle of the protective layer surface and water are brought into predetermined ranges, and further, the center plane average roughness (Sra) in a coating direction at a cutoff value of 0.8 mm, measured with a stylus type three-dimensional surface roughness tester, are brought into predetermined ranges, whereby there can be obtained a thermal recording material having a protective layer, which is excellent in offset printability and which has suitable surface strength and color developability in thermal printing.

Further, when the protective layer contains a pigment component having an oil absorption, measured according to JIS-K-5101, of 200 ml/100 g to 350 ml/100 g, a water-dispersible resin or a non-modified polyvinyl alcohol is used as a resin in the protective layer, and 40 mass % to 70 mass %, based on the entire solid content of the protective layer, of the pigment component is incorporated, whereby there can be further obtained superior effects. Further, a silicon-modified polyvinyl alcohol is used as a resin in the above protective layer, the above protective layer contains a high-molecular-weight crosslinking agent, preferably, a high-molecular-weight crosslinking agent having a glycidyl group and containing polyamidemaine as a main chain and a low-molecular-weight crosslinking agent, preferably, a low-molecular-weight crosslinking agent having an aldehyde group, these crosslinking agents being used in amounts of 2 mass % to 10 mass % and 2 mass % to 8 mass %, respectively, based on the solid content of the resin, and further, the above protective layer contains a pigment in an amount of 10 mass % to 50 mass % based on the total solid content of the protective layer, whereby there can be further obtained excellent results.

### INDUSTRIAL UTILITY

The thermal recording material of the present invention is excellent in lithographic offset printability and is useful as various recording paper sheets.

1. A thermal recording material for offset printing, comprising a support, a thermal recording layer for thermally developing a color and a protective layer containing a pigment and a resin, the thermal recording layer being formed on the support, the protective layer being formed on the thermal recording layer, wherein the transfer amount of water on the surface of said protective layer for a contact time period of 150 ms, measured by a Bristow method, is 3 ml/m² to 15 ml/m² and the contact angle between the surface of said protective layer and water is 60° to 100°.

2. The thermal recording material for offset printing as recited in claim 1, wherein the transfer amount of water on the surface of said protective layer for a contact time period of 150 ms, measured by a Bristow method, is 7 ml/m² to 10 ml/m².

3. The thermal recording material for offset printing as recited in claim 1, wherein the contact angle between the surface of said protective layer and water is 70° to 90°.

4. The thermal recording material for offset printing as recited in claim 1, wherein the surface of said protective layer has a center plane average roughness (SRa), measured with a stylus type three-dimensional surface roughness tester, of 0.6 μm to 2 μm in a coating direction at a cutoff value of 0.8 mm.

5. The thermal recording material for offset printing as recited in claim 1, wherein the surface of said protective layer has a center plane average roughness (SRa), measured with a stylus type three-dimensional surface roughness tester, of 0.6 μm to 1 μm in a coating direction at a cutoff value of 0.8 mm.

6. The thermal recording material for offset printing as recited in claim 1, wherein the pigment contained in the said protective layer has an oil absorption, measured according to JIS-K-5101, of 200 ml/100 g to 350 ml/100 g.

7. The thermal recording material for offset printing as recited in claim 1, wherein the pigment contained in the said protective layer has an oil absorption, measured according to JIS-K-5101, of 250 ml/100 g to 300 ml/100 g.

8. The thermal recording material for offset printing as recited in claim 1, wherein the resin in said protective layer is at least one member of a water-dispersible resin and a non-modified polyvinyl alcohol and said protective layer has a pigment content of 40 mass % to 70 mass % based on the total solid content of said protective layer.

9. The thermal recording material for offset printing as recited in claim 1, wherein the transfer amount of water on the surface of said protective layer for a contact time period of 150 ms, measured by a Bristow method, is 7 ml/m² to 10 ml/m², the contact angle between the surface of said protective layer and water is 70° to 90°, the surface of said protective layer has a center plane average roughness (SRa), measured with a stylus type three-dimensional surface roughness tester, of 0.7 μm to 2.0 μm in a coating direction at a cutoff value of 0.8 mm, the resin in said protective layer is at least one member of a water-dispersible resin and a non-modified polyvinyl alcohol, the pigment has an oil absorption, measured according to JIS-K-5101, of 250 ml/100 g to 300 ml/100 g and said protective layer has a pigment content of 40 mass % to 70 mass % based on the total solid content of said protective layer.

10. The thermal recording material for offset printing as recited in claim 1, wherein the resin in said protective layer is a silicon-modified polyvinyl alcohol and the protective layer contains a high-molecular-weight crosslinking agent and a low-molecular-weight crosslinking agent.

11. The thermal recording material for offset printing as recited in claim 10, wherein said high-molecular-weight crosslinking agent contains a glycidyl group and contains polyamideamine as a main chain.

12. The thermal recording material for offset printing as recited in claim 10, wherein said low-molecular-weight crosslinking agent is a compound having an aldehyde group.

13. The thermal recording material for offset printing as recited in claim 10, wherein said high-molecular-weight crosslinking agent contains a glycidyl group and contains polyamideamine as a main chain, and said low-molecular-weight crosslinking agent is a compound having an aldehyde group.

14. The thermal recording material for offset printing as recited in claim 13, wherein said high-molecular-weight crosslinking agent is contained in an amount of 2 mass % to 10 mass % based on the solid content of the resin in said protective layer and said low-molecular-weight crosslinking agent is contained in an amount of 2 mass % to 8 mass % based on the solid content of the resin in said protective layer.

15. The thermal recording material for offset printing as recited in claim 10, wherein the surface of said protective layer has a center plane average roughness (SRa), measured with a stylus type three-dimensional surface roughness tester, of 0.6 μm to 2 μm in a coating direction at a cutoff value of 0.8 mm.

16. The thermal recording material for offset printing as recited claim 10, wherein said protective layer has a pigment content of 10 mass % to 50 mass % based on the total solid content of said protective layer.

17. The thermal recording material for offset printing as recited in claim 13, wherein the transfer amount of water on the surface of said protective layer for a contact time period of 150 ms, measured by a Bristow method, is 3 ml/m² to 10 ml/m², the contact angle between the surface of said protective layer and water is 70° to 90°, the surface of said protective layer has a center plane average roughness (SRa), measured with a stylus type three-dimensional surface roughness tester, of 0.6 μm to 2 μm in a coating direction at a cutoff value of 0.8 mm, and said protective layer has a pigment content of 10 mass % to 50 mass % based on the total solid content of said protective layer.
